(19) United States
(12) Patent Application Publication
(10) Pub. No.: US 2012/0023161 A1
(43) Pub. Date: Jan. 26, 2012

(54) SYSTEM AND METHOD FOR PROVIDING MULTIMEDIA SERVICE IN A COMMUNICATION SYSTEM

(75) Inventors: Seong-Yong LIM, Daejeon (KR); In-Jae LEE, Daejeon (KR); Ji-Hun CHA, Daejeon (KR); Young-Kwon LIM, Gyeonggi-do (KR); Min-Sik PARK, Daejeon (KR); Han-Kyu LEE, Daejeon (KR); Jin-Woong KIM, Daejeon (KR); Joong-Yun LEE, Seoul (KR)

(73) Assignees: SK Telecom Co., Ltd., Seoul (KR); Electronics and Telecommunications Research Institute, Daejeon (KR)

(21) Appl. No.: 13/187,604

(22) Filed: Jul. 21, 2011

(30) Foreign Application Priority Data
Jul. 21, 2010 (KR) 10-2010-0070658
Jul. 23, 2010 (KR) 10-2010-0071515
Jul. 20, 2011 (KR) 10-2011-0071885
Jul. 20, 2011 (KR) 10-2011-0071886

(51) Int. Cl. G06F 15/16

(52) U.S. Cl. 709/203

(57) ABSTRACT

Disclosed herein are a system and a method for providing multimedia services capable of providing various types of multimedia contents and information sensed at multi-points to users at a high rate and in real time at the time of providing the multimedia contents and sense scene representation and sensory effects for multimedia contents corresponding to multimedia services through the multi-points according to service requests of the multimedia services that users want to receive, encode and transmit the sensed information for scene representation and sensory effects with binary representation according to the sensing, transmit device command data for the sensed scene representation and sensory effects, drive and control user devices according the device command data to provide the scene representation and the sensory effects for the multimedia contents to the users.

### CROSS-REFERENCES TO RELATED APPLICATIONS

The present application claims priority of Korean Patent Application Nos. 10-2010-0070658, 10-2010-0071515, 10-2011-0071885, and 10-2011-0071886, filed on Jul. 21, 2010, Jul. 23, 2010, Jul. 20, 2011, and Jul. 20, 2011, respectively, which are incorporated herein by reference in their entirety.

### BACKGROUND OF THE INVENTION

1. Field of the Invention

Exemplary embodiments of the present invention relate to a communication system, and more particularly, to a system and a method for providing multimedia services capable of providing various types of multimedia contents and information sensed at multi-points to users at a high rate and in real time at the time of providing the multimedia contents.

2. Description of Related Art

In a communication system, a study for providing services having various quality of services (hereinafter, referred to as ‘QoS’) to users at a high transmission rate has been actively conducted. In the communication system, methods for providing services requested by each user by quickly and stably transmitting various types of service data to users through a limited resource according to service requests of users wanting to receive various types of services have been proposed.

Meanwhile, in the current communication system, methods for transmitting large-capacity service data at a high rate according to various service requests of users have been proposed. In particular, research into methods for transmitting large-capacity multimedia data at a high rate, corresponding to service requests of users wanting to receive various multimedia services has been actively conducted. In other words, the users want to receive a higher quality of various multimedia services through the communication system. In particular, the users want to receive a higher quality of multimedia services by receiving multimedia contents corresponding to multimedia services and various sensory effects for the multimedia contents.

However, the current communication system has a limitation in providing the multimedia services requested by the users by transmitting the multimedia contents according to the multimedia service requests of the users. In particular, in the current communication system, detailed methods for transmitting multimedia contents and information acquired at multi-points as various sensed information for user interaction with user devices, for example, additional data for the multimedia contents to the users at the time of providing the multimedia contents, corresponding to a higher quality of various multimedia service requests of the users as described above, have not yet been proposed. That is, in the current communication system, detailed methods for providing a high quality of various multimedia services to each user in real time by transmitting the multimedia contents and the additional data for the multimedia contents at a high rate have not yet been proposed.

Therefore, a need exists for a method for providing a high quality of various large-capacity multimedia services at a high rate corresponding to service requests of users, in particular, for providing a high quality of various large-capacity multimedia services requested by each user in real time.

### SUMMARY OF THE INVENTION

An embodiment of the present invention is directed to provide a system and a method for providing multimedia services in a communication system.

In addition, another embodiment of the present invention is directed to provide a system and a method for providing multimedia services capable of providing a high quality of various multimedia services at a high rate and in real time according to service requests of users in a communication system.

Another embodiment of the present invention is directed to provide a system and a method for providing multimedia services capable of providing a high quality of various multimedia services to each user in real time by transmitting multimedia contents of multimedia services that each user wants to receive and information acquired at multi-points at a high rate at the time of providing the multimedia contents, in a communication system.

In accordance with an embodiment of the present invention, a system for providing multimedia services in a communication system includes: a sensing unit configured to sense scene representation and sensory effects for multimedia contents corresponding to multimedia services according to service requests of the multimedia services that users want to receive; a generation unit configured to generate sensed information corresponding to sensing of the scene representation and the sensory effects; and a transmitting unit configured to encode the sensed information with binary representation and transmit the encoded sensed information to a server.

In accordance with another embodiment of the present invention, a system for providing multimedia services in a communication system includes: a receiving unit configured to receive sensed information at multi-points for scene representation and sensory effects for multimedia contents corresponding to the multimedia services from the multi-points according to service requests that users want to receive; a generation unit configured to generate event data and device command data corresponding to the sensed information; and a transmitting unit configured to encode the device command data with binary representation and transmit the encoded device command data to the user devices.

In accordance with another embodiment of the present invention, a method for providing multimedia services in a communication system includes: sensing scene representation and sensory effects for multimedia contents corresponding to multimedia services through multi-points according to service requests of the multimedia services that users want to receive; generating sensed information for the scene representation and the sensor effects corresponding to sensing at the multi-points; and encoding the sensed information with binary representation and transmitting the encoded sensed information.

In accordance with another embodiment of the present invention, a method for providing multimedia services in a communication system includes receiving sensed information at multi-points for scene representation and sensory effects for multimedia contents corresponding to the multimedia services according to service requests of multimedia services that users want to receive; generating event data corresponding to the sensed information; generating device command data based on the sensed information and the event data; and encoding and transmitting the device command data by binary representation so as to drive and control user devices.

### BRIEF DESCRIPTION OF THE DRAWINGS

FIG. 1 is a diagram schematically illustrating a structure of a system for providing multimedia services in accordance with an exemplary embodiment of the present invention.

FIG. 2 is a diagram schematically illustrating a structure of a sensor in the system for providing multimedia services in accordance with the exemplary embodiment of the present invention.

FIGS. 3 to 5 are diagrams schematically illustrating a structure of sensor information in the system for providing multimedia services in accordance with the exemplary embodiment of the present invention.

FIG. 6 is a diagram schematically illustrating an operation process of multi-points in the system for providing multimedia services in accordance with the exemplary embodiment of the present invention.

FIG. 7 is a diagram schematically illustrating a structure of a server in the system for providing multimedia services in accordance with the exemplary embodiment of the present invention.

FIG. 8 is a diagram schematically illustrating an operation process of the server in the system for providing multimedia services in accordance with the exemplary embodiment of the present invention.

### DESCRIPTION OF SPECIFIC EMBODIMENTS

Exemplary embodiments of the present invention will be described below in more detail with reference to the accompanying drawings. Only portions needed to understand an operation in accordance with exemplary embodiments of the present invention will be described in the following description. It is to be noted that descriptions of other portions will be omitted so as not to make the subject matters of the present invention obscure.

Exemplary embodiments of the present invention proposes a system and a method for providing multimedia services capable of providing a high quality of various multimedia services at a high rate and in real time in a communication system. In this case, the exemplary embodiments of the present invention provide a high quality of various multimedia services requested by each user in real time by transmitting multimedia contents of multimedia services to be provided to each user and information acquired at multi-points to users at a high rate at the time of providing the multimedia contents, according to service requests of users wanting to receive a high quality of various services.

Further, the exemplary embodiments of the present invention transmit multimedia contents and information, for example, additional data for the multimedia contents, acquired at multi-points as various sensed information for user interaction with user devices to the users at a high rate at the time of providing the multimedia contents, corresponding to a higher quality of various multimedia service requests of the users, thereby providing the high quality of various multimedia services at a high rate and in real time. Herein, the additional data for the multimedia contents include scene representation for the multimedia contents or additional services through an operation of external devices according to the scene representation, that is, information acquired by being sensed at multi-points so as to provide various sensory effects for the multimedia contents to the users, at the time of providing the multimedia services. In this case, the high quality of various multimedia services requested by each user may be provided in real time by transmitting the information acquired at the multi-points and the multimedia contents at a high rate and in real time.

Further, so as to provide the high quality of various multimedia services, the exemplary embodiments of the present invention encode the information acquired by being sensed at the multi-points at the time of providing the multimedia contents, that is, the sensed information through binary representation so as to minimize a data size of the sensed information, such that the multimedia contents and the sensed information at the multi-points for the multimedia contents are transmitted at a high rate, thereby providing the multimedia contents and the scene representation and the sensory effects according to the operations of the external devices for the multimedia contents to each user in real time, that is, the high quality of various multimedia services to the users in real time.

Further, the exemplary embodiments of the present invention transmit the information acquired at the multi-points for user interaction with the user devices, that is, the sensed information at a high rate and provide the multimedia contents and the various scene representations and the sensor effects for the multimedia contents to each user receiving the multimedia services in real time, by using a binary representation coding method at the time of providing various multimedia services in moving picture experts group (MPEG)-V. In particular, the exemplary embodiments of the present invention define a data format for describing the multi-points and the information acquired through the sensing of the external sensors, that is, the sensed information in Part 5 of MPEG-V and encode data including the sensed information with the binary representation and transmit the encoded data at a high rate to provide the multimedia contents and the additional services corresponding to the sensed information, for example, the scene representation and the sensory effects to the users in real time, thereby providing the high quality of various multimedia services to the users in real time.

In addition, the exemplary embodiments of the present invention define a data format for describing device command data that drive and control the user devices providing the various scene representations and the sensory effects for the multimedia contents to the users in real time through the user interaction according to the multi-points and the information acquired through the sensing of the external sensors, that is, the sensed information, in the Part 5 of MPEG-V. In other words, the exemplary embodiments of the present invention encodes the device command defined corresponding to the sensed information with the binary representation coding method and transmits the encoded device command at a high rate so as to provide the multimedia contents to the users and the additional services corresponding to the sensed information, for example, the scene representation and the sensory effects to the users in real time, thereby providing the high quality of various multimedia services to the users in real time.

The exemplary embodiments of the present invention encode the multi-points and the sensed information acquired through the sensing of the external sensors with the binary representation and transmit the encoded multi-points and sensed information to a server at a high rate in the Part 5 of MPEG-V, wherein the server transmits the multimedia contents of the multimedia services and the data corresponding to the sensed information to the user devices providing the real multimedia services to the users. In this case, the server receives the sensed information encoded with the binary representation, that is, the sensed information data from the multi-points and the external sensors and generates event data for describing the sensed information from the received sensed information data and then generates the device command data driving and controlling the user devices according to the sensed information using the event data and transmits the generated device command data to the user devices.

Meanwhile, in the Part 5 of MPEG-V, the server, the server may be a light application scene representation (LASeR) server for the user interaction with the user devices and the user devices may be actuators that provide the multimedia contents and the sensory effects for the multimedia contents to the users through the scene representation and the representation of the sensed information. In addition, the server encodes the device command data with the binary representation and transmits the encoded device command data to the user devices, that is, the plurality of actuators.

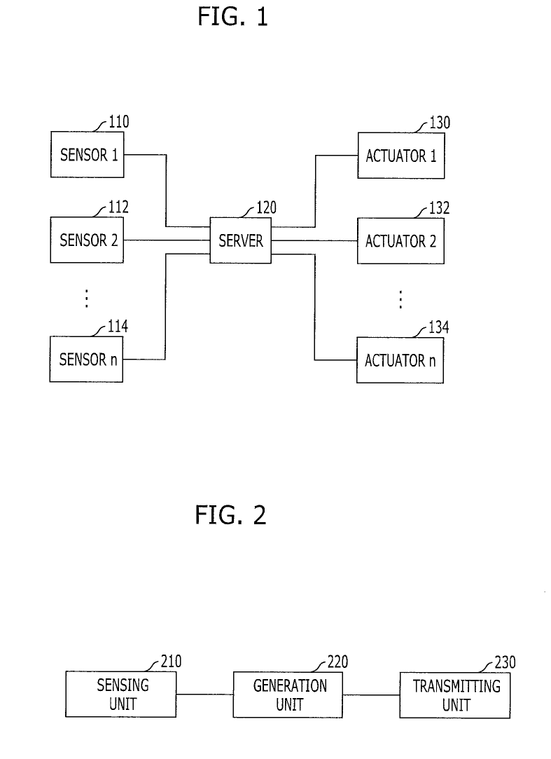

Further, in the Part 5 of MPEG-V in accordance with the exemplary embodiments of the present invention, the multi-points, the external sensors, and the server each define schemas for efficiently describing the multimedia contents and the sensed information and the device command data for the multimedia contents, and in particular, the sensed information and the device command data transmitted together with the multimedia contents are described and transmitted with an eXtensible markup language (hereinafter, referred to as ‘XML’) document so as to provide the high quality of various multimedia services. For example, the multi-points and the external sensors each define the sensed information by the XML document schema and then, encode the sensed information with the binary representation and transmit the encoded sensed information to the server and the server receives the sensed information and then, generates the event data through the sensed information and generates the device command data encoded with the binary representation using the event data and transmits the generated device command data to each actuator, thereby providing the high quality of various multimedia services to the users through each actuator. Hereinafter, a system for providing multimedia services in accordance with exemplary embodiments of the present invention will be described in more detail with reference to FIG. 1.

FIG. 1 is a diagram schematically illustrating a structure of a system for providing multimedia services in accordance with an exemplary embodiment of the present invention.

Referring to FIG. 1, the system for providing multimedia services includes sensors, for example, sensor 1 110, sensor 2 112, and sensor n 114 that transmit sensed information at the time of providing a high quality of various multimedia services that each user wants to receive according to service requests of the users, a server 120 that provides multimedia contents and the sensed information corresponding to the multimedia services to users, and actuators, for example, actuator 1 130, actuator 2 132, and actuator n 134 that provide the high quality of various multimedia services to the users using the multimedia contents and the sensed information provided from the server 120.

The sensors 110, 112, and 114 senses scene representation and sensor effects for the multimedia contents so as to provide the scene representation and the sensory effects for the multimedia contents of the multimedia services through user interaction with user devices, that is, the actuators 130, 132, and 134 at the time of providing the multimedia services, so as to provide the high quality of various multimedia services to the users. In addition, the sensors 110, 112, and 114 acquire the sensed information through the sensing and encode the sensed information with binary representation and then, the sensed information data encoded with the binary representation to the server 120.

That is, the sensed information acquired from the sensors 110, 112, and 114 is encoded with the binary representation. In other words, the sensors 110, 112, and 114 encode the sensed information using a binary representation coding method and transmit the encoded sensed information, that is, the sensed information data to the server 120. As described above, the sensors 110, 112, and 114 are devices that sense the scene representation and the sensory effects for the multimedia contents to acquire and generate the sensed information, which include multi-points and external sensors.

The server 120 confirms the sensed information data received from the sensors 110, 112, and 114 and then, generates event data for the multimedia contents according to the sensed information of the sensed information data. In other words, the server 120 generates the event data in consideration of the sensed information so as to provide the scene representation and the sensory effects for the multimedia contents as the sensed information to the users.

Further, the server 120 generates device command data driving and controlling the user devices, that is, the actuators 130, 132, and 134 that actually provides the scene representation and the sensory effects for the multimedia contents to the users at the time of providing the multimedia services in consideration of the generated event data and transmits the generated device command data to the actuators 130, 132, and 134.

In this case, the device command data become the driving and control information of the actuators 130, 132, and 134 so as to allow the actuators 130, 132, and 134 to provide the scene representation and the sensory effects for the multimedia contents to the users corresponding to the sensed information. In addition, the device command data are encoded with the binary representation, that is, the server 120 transmits the device command data encoding the driving and control information of the actuators 130, 132, and 134 with the binary representation coding method to the actuators 130, 132, and 134. Further, the server 120 encodes the multimedia contents of the multimedia services with the binary representation coding method and transmits the encoded multimedia contents to the actuators 130, 132, and 134.

The actuators 130, 132, and 134 receive the device command data encoded with the binary representation from the server 120 and is driven and controlled according to the device command data. That is, the actuators 130, 132, and 134 provide the scene representation and the sensory effects for the multimedia contents to the users according to the device command data, thereby providing the high quality of various multimedia services to the users. Hereinafter, the sensors, that is, the multi-points in the system for providing multimedia services in accordance with the exemplary embodiments of the present invention will be described in more detail with reference to FIG. 2.

FIG. 2 is a diagram schematically illustrating a structure of a sensor in the system for providing multimedia services in accordance with the exemplary embodiment of the present invention.

Referring to FIG. 2, the sensor includes a sensing unit 210 that senses the scene representation and the sensory effects, or the like, for the multimedia contents so as to provide the high quality of various multimedia services to the users, a generation unit 220 that generates sensed information data using the sensed information acquired through the sensing of the sensing unit 210, and a transmitting unit 230 that transmits the sensed information data generated from the generation unit 220 to the sever 120.

The sensing unit 210 senses the scene representation and the sensory effects for the multimedia contents so as to provide the scene representation and the sensory effects for the multimedia contents of the multimedia services through the user interaction at the time of providing the multimedia services.

Further, the generation unit 220 acquires the sensed information through the sensing of the sensing unit 210 and encodes the sensed information with the binary representation to generate the sensed information data. In addition, the transmitting unit 230 transmits the sensed information data encoded with the binary representation to the server 120.

Herein, the sensed information is defined as the types and attributes of the sensor, that is, the types and attributes of the multi-points. The sensed information includes, for example, a light sensor type, an ambient noise sensor type, a temperature sensor type, a humidity sensor type, a distance sensor type, a length sensor type, an atmospheric pressure sensor type, a position sensor type, a velocity sensor type, an acceleration sensor type, an orientation sensor type, an angular velocity sensor type, an angular acceleration sensor type, a force sensor type, a torque sensor type, a pressure sensor type, a motion sensor type, an intelligent camera sensor type, or the like, according to the types of the sensor. In addition, the sensed information includes a multi interaction point sensor type (or, multi point sensor type), a gaze tracking sensor type, and a wind sensor type.

In addition, the sensed information defines the types and attributes of the sensor as shown in Tables 1 and 2. The attributes defined in the sensed information may be represented by a timestamp and a unit. In Tables 1 and 2, ‘f.timestamp’ means a float type of timestamp attribute and ‘s.unit’ means a string type of unit attribute. That is, the attributes defined in the sensed information is defined as the time stamp and the unit.

TABLE 1

| | Sensor type | Attributes |
|---|---|---|
| Sened | Light sensor | f.timestamp, s.unit, f.value, s.color |
| Information | | |
| | Ambient noise | f.timestamp, s.unit, f.value |
| | sensor | |
| | Temperature sensor | f.timestamp, s.unit, f.value |
| | Humidity sensor | f.timestamp, s.unit, f.value |
| | Distance sensor | f.timestamp, s.unit, f.value |
| | Length sensor | f.timestamp, s.unit, f.value |
| | Atmospheric | f.timestamp, s.unit, f.value |
| | pressure sensor | |
| | Position sensor | f.timestamp, s.unit, f.Px, |
| | | f.Py, f.Pz |
| | Velocity sensor | f.timestamp, s.unit, f.Vx, |
| | | f.Vy, f.Vz |
| | Acceleration sensor | f.timestamp, s.unit, f.Ax, |
| | | f.Ay, f.Az |
| | Orientation sensor | f.timestamp, s.unit, f.Ox, |
| | | f.Oy, f.Oz |
| | Angular velocity | f.timestamp, s.unit, f.AVx, |
| | sensor | f.AVy, f.AVz |
| | Angular | f.timestamp, s.unit, f.AAx, |
| | acceleration sensor | f.AAy, f.AAz |
| | Force sensor | f.timestamp, s.unit, f.FSx, |
| | | f.FSy, f.FSz |
| | Torque sensor | f.timestamp, s.unit, f.TSx |
| | | f.TSy f.TSz |
| | Pressure sensor | f.timestamp, s.unit, f.value |
| | Motion sensor | f.timestamp, f.Px, f.Py, f.Pz, |
| | | f.Vx, f.Vy, f.Vz, f.Ox, f.Oy, |
| | | f.Oz, f.AVx, f.AVy, f.Avz, |
| | | f.Ax, f.Ay, f.Az, f.AAx, |
| | | f.AAy, f.AAz |
| | Intelligent Camera | f.timestamp, |
| | | FacialAnimationID, |
| | | BodyAnimationID, |
| | | FaceFeatures(f.Px f.Py f.Pz), |
| | | BodyFeatures(f.Px f.Py f.Pz) |
| | Multi point sensor | f.timestamp, f.Px, f.Py, f.Pz, |
| | | f.value |
| | Gaze tracking | f.timestamp, f.Px, f.Py, f.Pz, |
| | sensor | f.Ox, f.Oy, f.Oz, f.value, |
| | | f.value |
| | Wind sensor | f.timestamp, f.Px, f.Py, f.Pz, |
| | | f.Vx, f.Vy, f.Vz |

TABLE 2

| | Sensor type | Attributes |
|---|---|---|
| Sened | Light sensor | f.timestamp, s.unit, f.value, |
| Information | | s.color |
| | Ambient noise | f.timestamp, s.unit, f.value |
| | sensor | |
| | Temperature sensor | f.timestamp, s.unit, f.value |
| | Humidity sensor | f.timestamp, s.unit, f.value |
| | Distance sensor | f.timestamp, s.unit, f.value |
| | Length sensor | f.timestamp, s.unit, f.value |
| | Atmospheric | f.timestamp, s.unit, f.value |
| | pressure sensor | |
| | Position sensor | f.timestamp, s.unit, f.Px, |
| | | f.Py, f.Pz |
| | Velocity sensor | f.timestamp, s.unit, f.Vx, |
| | | f.Vy, f.Vz |
| | Acceleration sensor | f.timestamp, s.unit, f.Ax, |
| | | f.Ay, f.Az |
| | Orientation sensor | f.timestamp, s.unit, f.Ox, |
| | | f.Oy, f.Oz |
| | Angular velocity | f.timestamp, s.unit, f.AVx, |
| | sensor | f.AVy, f.AVz |
| | Angular | f.timestamp, s.unit, f.AAx, |
| | acceleration sensor | f.AAy, f.AAz |
| | Force sensor | f.timestamp, s.unit, f.FSx, |
| | | f.FSy, f.FSz |
| | Torque sensor | f.timestamp, s.unit, f.TSx |
| | | f.TSy f.TSz |
| | Pressure sensor | f.timestamp, s.unit, f.value |
| | Motion sensor | f.timestamp, f.Px, f.Py, f.Pz, |
| | | f.Vx, f.Vy, f.Vz, f.Ox, f.Oy, |
| | | f.Oz, f.AVx, f.AVy, f.Avz, |
| | | f.Ax, f.Ay, f.Az, f.AAx, |
| | | f.AAy, f.AAz |
| | Intelligent Camera | f.timestamp, |
| | | FacialAnimationID, |
| | | BodyAnimationID, |
| | | FaceFeatures(f.Px f.Py f.Pz), |
| | | BodyFeatures(f.Px f.Py f.Pz) |
| | Multi Interaction | f.timestamp, f.value |
| | point sensor | |
| | Gaze tracking | f.timestamp, f.Px, f.Py, f.Pz, |
| | sensor | f.Ox, f.Oy, f.Oz, f.value |
| | Wind sensor | f.timestamp, f.Vx, f.Vy, f.Vz |

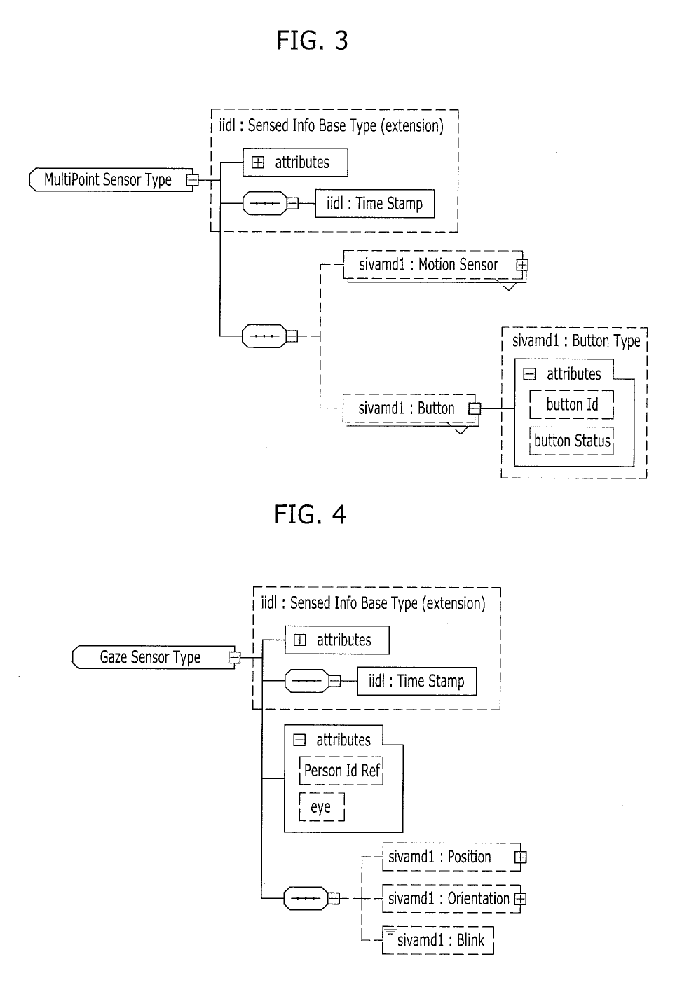

As such, as shown in Tables 1 and 2, the sensed information defined as the types and attributes, that is, the light sensor type, the ambient noise sensor type, the temperature sensor type, the humidity sensor type, the distance sensor type, the length sensor type, the atmospheric pressure sensory type, the position sensor type, the velocity sensor type, the acceleration sensor type, the orientation sensor type, the angular velocity sensor type, the angular acceleration velocity sensor type, the force sensor type, the torque sensor type, the pressure sensor type, the motion sensor type, the intelligent camera sensor type, the multi interaction point sensor type (or multi point sensor type), the gaze tracking sensor type, and the wind sensor type are represented by the XML document and are encoded by the binary representation and transmitted to the server. Hereinafter, the sensor information will be described in more detail with reference to FIGS. 3 to 5.

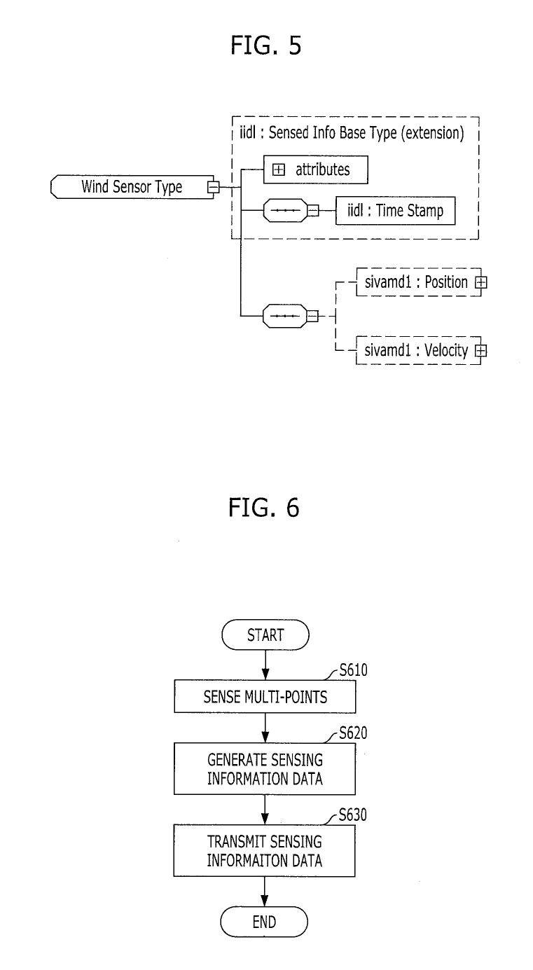

FIGS. 3 to 5 are diagrams schematically illustrating a structure of sensor information in the system for providing multimedia services in accordance with the exemplary embodiment of the present invention. FIG. 3 is a diagram illustrating a structure of a multi interaction point sensor type, FIG. 4 is a diagram illustrating a structure of a gaze tracking sensor type, and FIG. 5 is a diagram illustrating a structure of a wind sensor type.

Referring to FIGS. 3 to 5, the multi interaction point sensor type (or multi-point sensor type), the gaze tracking sensor type, and the wind sensor type have an extension structure of the sensed info based type and the sensed information based type includes attributes and timestamps. In addition, the multi interaction point sensor type (or multi-point sensor type), the gaze tracking sensor type, and the wind sensor type are represented by the XML document and are encoded with the binary representation and transmitted to the server.

Describing in more detail, the multi interaction point sensor type is represented by the XML document as shown in Table 3. Table 3 shows XML representation syntax of the multi interaction point sensor type.

TABLE 3

```
<!-- ################################################ -->
<!-- Definition of Multi Interaction Point Sensor Type -
->
<!-- ################################################ -->
<complexType name=“MultiInteractionPointSensorType”>
    <annotation>
        <documentation>MultiInteractionPoint Sensed
Information Structure</documentation>
    </annotation>
    <complexContent>
        <extension base=“iidl:SensedInfoBaseType”>
            <sequence>
                <element name=“InteractionPoint”
type=“sivamd1: InteractionPointType” minOccurs=“0”
maxOccurs=“unbounded”/>
            </sequence>
        </extension>
    </complexContent>
</complexType>
<complexType name=“InteractionPointType”>
    <attribute name=“interactionPointId” type=“ID”/>
    <attribute name=“interactionPointStatus” type=“boolean”
default=“false”/>
</complexType>
```

As shown in Table 3, descriptor components semantics of the multi interaction point sensor type represented by the XML representation syntax may be shown as in Table 4.

TABLE 4

| Name | Definition |
|---|---|
| MultiInteractionPointSensorType | Tool for describing sensed |
| | information captured by multi |
| | interaction point sensor. |
| | EXAMPLE Multi-point devices such |
| | as multi-touch pad, multi-finger |
| | detecting device, etc. |
| TimeStamp | Describes the time that the |
| | information is sensed. |
| InteractionPoint | Describes the status of an |
| | interaction point which is included |
| | in a multi interaction point sensor. |
| InteractionPointType | Describes the referring |
| | identification of an interaction |
| | point and the status of an |
| | interaction point. |
| interactionPointId | Describes the identification of |
| | associated interaction point. |
| interactionPointStatus | Indicates the status of an |
| | interaction point which is included |
| | in a multi interaction point sensor. |

In addition, the multi-point sensor type may be represented by the XML document as shown in Table 5. Table represents the XML representation syntax of the multi-point sensor type.

```
TABLE 5
<!-- ################################################ -->
<!-- Definition of Multi Pointing Sensor Type -->
<!-- ################################################ -->
<complexType name=“MultiPointingSensorType”>
    <annotation>
        <documentation>MultiPointing Sensed Information
Structure</documentation>
    </annotation>
    <complexContent>
        <extension base=“iidl:SensedInfoBaseType”>
            <sequence>
```

| | |
|---|---|
| <element | name=“MotionSensor” |
| type=“siv:MotionSensorType” | minOccurs=“0” |
| maxOccurs=“unbounded”/> | |
| <element | name=“Button” |

```
type=“sivamd1:ButtonType” minOccurs=“0” maxOccurs=“unbounded”/>
            </sequence>
        </extension>
    </complexContent>
</complexType>
<!-- -->
<complexType name=“ButtonType”>
    <attribute name=“buttonId” type=“ID”/>
    <attribute name=“buttonStatus” type=“boolean”/>
</complexType>
```

Further, as shown in Table 5, the descriptor components semantics of the multi-point sensor type represented by the XML representation syntax may be shown as in Table 6.

TABLE 6

| Name | Definition |
|---|---|
| MultiInteractionPointSensorType | Multi-point acquisition information |
| | (Tool for describing sensed |
| | information captured by none or more |
| | motion sensor combined with none or |
| | more button). |
| | EXAMPLE Multi-pointing devices |
| | such as multi-touch pad, multi-finger |
| | detecting device, etc. |
| MotionSensor | Position information of feature |
| | points that can be acquired from |
| | motion sensor (Describes pointing |
| | information of multi-pointing devices |
| | which is defined as Motion Sensor |
| | Type). |
| Button | Button information (Describes the |
| | status of buttons which is included |
| | in a multi-pointing device). |
| ButtonType | Button information (Describes the |
| | referring identification of a Button |
| | device and the status of a Button). |
| buttonId | Button ID(Describes the |
| | identification of associated Button |
| | device). |
| buttonStatus | Status of button (Indicates the |
| | status of a button which is included |
| | in a multi-pointing device). |

In Tables 4 and 6, a ‘Motion Sensor’ descriptor describes the position information of the multi-points as spatial coordinates of x, y, and z and the ‘Interaction Point’ and ‘Button’ descriptors are acquired the sensed information through the sensing and encodes the acquired sensed information with the binary representation and then, describes whether or not to select the multi-points transmitting the sensed information data to the server.

The multi interaction point sensor type having the XML representation syntax and the descriptor components semantics is encoded with the binary representation. The sensor type encoded with the binary representation, that is, the sensed information encoded with the binary representation in the sensor is transmitted to the server as the sensed information data. In this case, the binary representation of the multi interaction point sensor type, that is, the sensed information in the multi interaction point sensor encoded with the binary representation may be shown as in Table 7. As shown in Table 7, the sensed information encoded with the binary representation, that is, the sensed information data are transmitted to the server. Table 7 is a table that shows the binary representation syntax of the multi interaction point sensor type.

TABLE 7

| | Number of | |
|---|---|---|
| MultiInteractionPointSensorType{ | bits | Mnemonic |
| SensedInfoBaseType | | SensedInfoBaseType |
| InteractionPointFlag | 1 | bslbf |
| if(InteractionPointFlag) | | |
| { | | |
| NumOfInteractionPoint | 8 | uimsbf |
| for( k=0; | | |
| k< | | |
| NumOfInteractionPoint; | | |
| k++ ) { | | |
| InteractionPoint [k] | | InteractionPointType |
| } | | |
| } | | |
| } | | |
| InteractionPointType { | | |
| interactionPointId | 8 | uimsbf |
| interactionPointStatus | 1 | bslbf |
| } | | |

In Table 7, mnemonic of the interaction point status may be shown as in Table 8.

TABLE 8

| Binary value | |
|---|---|
| (1 bits) | status of interaction point |
| 0 | false |
| 1 | true |

In this case, an example of set description of the multi interaction point sensor type may be shown as in Table 9. Table 9 is a table that represents the set description of the multi interaction point sensor type.

TABLE 9

```
<iidl:SensedInfo xsi:type=“siv:MultiInteractionPointSensorType”
id=“MIPS001” sensorIdRef=“MIPSID001” activate=“true”>
  <iidl:TimeStamp xsi:type=“mpegvct:ClockTickTimeType”
timeScale=“1000” pts=“50000”/>
  <siv:InteractionPoint interactionPointId=“IPT001”
interactionPointStatus=“false”/>
  <siv:InteractionPoint interactionPointId=“IPT002”
interactionPointStatus=“true”/>
</iidl:SensedInfo>
```

Next, the gaze tracking sensor type is represented by the XML document as shown in Table 10. Table 10 shows the XML representation syntax of the gaze tracking sensor type.

TABLE 10

```
<!-- ################################################ -->
<!-- Definition of Gaze Tracking Sensor Type  -->
<!-- ################################################ -->
<complexType name=“GazeTackingSensorType”>
  <annotation>
    <documentation>Gaze Tracking Sensed Information
Structure</documentation>
  </annotation>
  <complexContent>
    <extension base=“iidl:SensedInfoBaseType”>
<sequence>
        <element name=“Gaze” type=“siv:GazeType”
maxOccurs=“2”/>
      </sequence>
      <attribute name=“personIdx” type=“anyURI”
use=“optional”/>
    </extension>
  </complexContent>
</complexType>
<complexType name=“GazeType”>
  <sequence>
    <element name=“Position”
type=“siv:PositionSensorType” minOccurs=“0”/>
    <element name=“Orientation”
type=“siv:OrientationSensorType” minOccurs=“0”/>
  </sequence>
  <attribute name=“gazeIdx” type=“anyURI” use=“optional”/>
  <attribute name=“blinkStatus” type=“boolean”
use=“optional” default=“false”/>
</complexType>
```

Further, as shown in Table 10, the descriptor component semantics of the gaze tracking sensor type represented by the XML representation syntax may be shown as in Table 11.

TABLE 11

| Name | Definition |
|---|---|
| GazeTrackingSensorType | Tool for describing sensed information |
| | captured by none or more gaze tracking |
| | sensor. |
| | EXAMPLE Gaze tracking sensor, etc. |
| TimeStamp | Describes the time that the information is |
| | sensed. |
| personIdx | Describes a index of the person who is being |
| | sensed. |
| Gaze | Describes a set of gazes from a person. |
| GazeType | Describes the referring identification of a |
| | set of gazes. |
| Position | Describes the position information of an eye |
| | which is defined as PositionSensorType. |
| Orientation | Describes the direction of a gaze which is |
| | defined as OrientationSensorType. |
| gazeIdx | Describes an index of a gaze which is sensed |
| | from the same eye. |
| blinkStatus | Describes the eye's status in terms of |
| | blinking. “false” means the eye is not |
| | blinking and “true” means the eye is |
| | blinking. |
| | Default value of this attribute is “false”. |

In addition, the gaze tracking sensor type may be represented by the XML document as shown in Table 12. Table 12 represents another XML representation syntax of the gaze tracking sensor type.

TABLE 12

```
<!-- ################################################ -->
<!-- Definition of Gaze Sensor Type -->
<!-- ################################################ -->
<complexType name=“GazeSensorType”>
  <annotation>
    <documentation>Gaze Sensed Information
Structure</documentation>
  </annotation>
  <complexContent>
    <extension base=“iidl:SensedInfoBaseType”>
      <sequence>
        <element name=“Position”
type=“siv:PositionSensorType” minOccurs=“0”/>
        <element name=“Orientation”
type=“siv:OrientationSensorType” minOccurs=“0”/>
        <element name=“Blink” type=“int”
minOccurs=“0”/>
      </sequence>
      <attribute name=“personIdRef” type=“anyURI”
use=“optional”/>
      <attribute name=“eye” type=“boolean”
use=“optional”/>
    </extension>
  </complexContent>
</complexType>
```

Further, as shown in Table 12, the descriptor components semantics of the gaze tracking sensor type represented by the XML representation syntax may be shown as in Table 13.

TABLE 13

| Name | Definition |
|---|---|
| GazeSensorType | Gaze tracking information (Tool for |
| | describing sensed information captured by |
| | none or more gaze sensor). |
| | EXAMPLE Gaze tracking sensor, etc. |
| Position | Position information of eye (Describes the |
| | position information of an eye which is |
| | defined as PositionSensorType). |
| Orientation | Orientation information of gaze (Describes |
| | the direction of a gaze which is defined as |
| | OrientationSensorType). |
| Blink | The number of eye's blinking (Describes the |
| | number of eye's blinking. |
| personIdRef | Reference of person including eyes (Describes |
| | the identification of associated person). |
| eye | Left and right eyes (Indicates which eye |
| | generates this gaze sensed information). |

In Tables 11 and 13, the ‘Position’ and ‘Orientation’ descriptors are described as the position and orientation of user's eyes and the ‘blinkStatus’ and ‘Blink’ descriptors are described as ‘on’ and ‘off’ according to the blink of user's eyes. In addition, the ‘gazeIdx’ and ‘gazeIdx’ descriptors are described with identifiers (IDs) of users and the ‘eye’ descriptor describes the left and right eyes of users and the orientation at which the left eye or the right eye gazes.

The gaze tracking sensor type having the XML representation syntax and the descriptor components semantics is encoded with the binary representation. The sensor type encoded with the binary representation, that is, the sensed information encoded with the binary representation in the sensor is transmitted to the server as the sensed information data. In this case, the binary representation of the gaze tracking sensory, that is, the sensed information in the gaze tracking sensor encoded with the binary representation may be shown as in Table 14. As shown in Table 14, the sensed information encoded with the binary representation, that is, the sensed information data are transmitted to the server. Table 14 is a table that represents the binary representation syntax of the gaze tracking sensor type.

TABLE 14

| | Number of | |
|---|---|---|
| GazeTrackingSensorType{ | bits | Mnemonic |
| SensedInfoBaseType | | SensedInfoBaseType |
| personIdxRefFlag | 1 | bslbf |
| if( personIdxRefFlag ) { | | |
| personIxdRef | 8 | uimsbf |
| } | | |
| NumOfGazes | 8 | uimsbf |
| for( k=0; | | |
| k< NumOfGazes; | | |
| k++ ) { | | |
| Gaze [k] | | GazeType |
| } | | |
| } | | |
| GazeType{ | | |
| PositionFlag | 1 | Bslbf |
| OrientationFlag | 1 | Bslbf |
| gazeIdxFlag | 1 | bslbf |
| blinkStatusFlag | 1 | bslbf |
| if( PositionFlag ) { | | |
| Position | | PositionSensorType |
| } | | |
| if( OrientatioinFlag ) { | | |
| Orientation | | OrientationSensorType |
| } | | |
| if( gazeIdxFlag ) { | | |
| gazeIdx | 8 | uimsbf |
| } | | |
| if( blinkStatusFlag ) { | | |
| blinkStatus | 1 | uimsbf |
| } | | |
| } | | |

In this case, an example of the set description of the gaze tracking sensor type may be represented as in Table 15. Table 15 is a table that represents the set description of the gaze tracking sensor type.

TABLE 15

```
<iidl:SensedInfo xsi:type=“sivamd1:GazeTrackingSensorType”
id=“GTS001” sensorIdRef=“GTSID001” activate=“true”
personIdx=“pSID001” >
  <iidl:TimeStamp xsi:type=“mpegvct:ClockTickTimeType”
timeScale=“1000” pts=“50000”/>
  <siv:Gaze gazeIdx=“gz001” blinkStatus=“false” >
    <siv:Position id=“PS001” sensorIdRef=“PSID001”>
      <siv:Position>
        <mpegvct:X>1.5</mpegvct:X>
        <mpegvct:Y>0.5</mpegvct:Y>
        <mpegvct:Z>−2.1</mpegvct:Z>
      </siv:Position>
    </siv:Position>
    <siv:Orientation id=“OS001” sensorIdRef=“OSID001”>
      <siv:Orientation>
        <mpegvct:X>1.0</mpegvct:X>
        <mpegvct:Y>1.0</mpegvct:Y>
        <mpegvct:Z>0.0</mpegvct:Z>
      </siv:Orientation>
    </siv:Orientation>
  </siv:Gaze>
  <siv:Gaze gazeIdx=“gz002” blinkStatus=“true” >
    <siv:Position id=“PS002” sensorIdRef=“PSID002”>
      <siv:Position>
        <mpegvct:X>1.7</mpegvct:X>
        <mpegvct:Y>0.5</mpegvct:Y>
        <mpegvct:Z>−2.1</mpegvct:Z>
      </siv:Position>
    </siv:Position>
    <siv:Orientation id=“OS002” sensorIdRef=“OSID002”>
      <siv:Orientation>
        <mpegvct:X>1.0</mpegvct:X>
        <mpegvct:Y>1.0</mpegvct:Y>
        <mpegvct:Z>0.0</mpegvct:Z>
      </siv:Orientation>
    </siv:Orientation>
  </siv:Gaze>
</iidl:SensedInfo>
```

Next, the wind sensor type is represented by the XML document as shown in Table 16. Table 16 shows the XML representation syntax of the wind sensor type.

TABLE 16

```
<!-- ################################################ -->
<!-- Definition of Wind Sensor Type -->
<!-- ################################################ -->
<complexType name=“WindSensorType”>
  <annotation>
    <documentation>Wind Sensed Information
Structure</documentation>
  </annotation>
  <complexContent>
    <extension base=“iidl: VelocitySensorType “/>
  </complexContent>
</complexType>
```

Further, as shown in Table 16, the descriptor component semantics of the wind sensor type represented by the XML representation syntax may be shown as in Table 17.

TABLE 17

| Name | Definition |
|---|---|
| WindSensorType | Tool for describing sensed information |
| | captured by none or more wind sensor. |
| | EXAMPLE wind sensor, etc. |
| Velocity | Describes the speed and direction of a wind |
| | flow. |

In addition, the wind sensor type may be represented by the XML document as shown in Table 18. Table 18 represents another XML representation syntax of the wind sensor type.

TABLE 18

```
<!-- ################################################ -->
<!--  Definition of Wind Sensor Type -->
<!-- ################################################ -->
<complexType name=“WindSensorType”>
  <annotation>
    <documentation>Wind Sensed Information
Structure</documentation>
  </annotation>
  <complexContent>
    <extension base=“iidl:SensedInfoBaseType”>
      <sequence>
        <element name=“Position”
type=“siv:PositionSensorType” minOccurs=“0”/>
        <element name=“Velocity”
type=“siv:VelocitySensorType” minOccurs=“0”/>
      </sequence>
    </extension>
  </complexContent>
</complexType>
```

Further, as shown in Table 18, the descriptor component semantics of the wind sensor type represented by the XML representation syntax may be shown as in Table 19.

TABLE 19

| Name | Definition |
|---|---|
| WindSensorType | Wind strength information (Tool for |
| | describing sensed information captured by |
| | none or more wind sensor). |
| | EXAMPLE wind sensor, etc. |
| Position | Position of acquired sensor(Describes the |
| | position information of a wind flow which is |
| | defined as PositionSensorType). |
| Velocity | Strength of wind (Describes the speed and |
| | direction of a wind flow). |

In Tables 17 and 19, the ‘velocity’ descriptor describes wind direction and wind velocity. For example, the ‘velocity’ descriptor describes wind direction and wind velocity at 2 m/s having an azimuth of 10°.

The wind sensor type having the XML representation syntax and the descriptor components semantics is represented by the binary representation and the sensor type encoded by the binary representation, that is, the sensed information encoded by the binary representation in the sensor is transmitted to the server as the sensed information data. In this case, the binary representation of the wind sensor type, that is, the sensed information in the wind sensor encoded with the binary representation may be shown as in Table 20. The sensed information encoded with the binary representation, that is, the sensing information data are transmitted to the server as shown in Table 20. Table 20 is a table that represents the binary representation syntax of the wind sensor type.

TABLE 20

| | Number of | |
|---|---|---|
| WindSensorType{ | bits | Mnemonic |
| Velocity | | VelocityType |
| } | | |

In this case, an example of the set description of the wind sensor type may be represented as in Table 21. Table 21 is a table that represents the set description of the wind sensor type.

```
TABLE 21
<iidl:SensedInfo xsi:type=“siv:WindSensorType” id=“WS001”
sensorIdRef=“WSID001” activate=“true” >
  <iidl:TimeStamp xsi:type=“mpegvct:ClockTickTimeType”
timeScale=“1000” pts=“50000”/>
  <siv:Velocity>
    <mpegvct:X>1.0</mpegvct:X>
    <mpegvct:Y>1.0</mpegvct:Y>
    <mpegvct:Z>0.0</mpegvct:Z>
  </siv:Velocity>
</iidl:SensedInfo>
```

As described above, the multimedia system in accordance with the exemplary embodiment of the present invention senses the scene representation and the sensory effects for the multimedia contents of the multimedia services in the multi-points so as to provide the high quality of various multimedia services requested by users at a high rate and in real time through the user interaction with the user devices at the time of providing the multimedia services in the MPEG-V and defines the data format for describing the sensed information acquired through the sensing, that is, defines the data format by the XML document schema and encodes and transmits the defined sensed information by the binary representation. The user interaction with the user devices is performed at the time of providing the multimedia services by transmitting the device command data to the user devices based on the sensed information encoded with the binary representation, such that the high quality of various multimedia services requested by the users are provided to the users at a high rate and in real time. Hereinafter, a transmission operation of the sensed information for providing multimedia services in the multimedia system in accordance with the exemplary embodiment of the present invention will be described in more detail with reference to FIG. 6.

FIG. 6 is a diagram schematically illustrating an operation process of the multi-points in the multimedia system in accordance with the exemplary embodiment of the present invention.

Referring to FIG. 6, at step 610, the multi-points sense the scene representation and the sensory effects for the multimedia contents of the multimedia services so as to provide the high quality of various multimedia services requested by the users in a high rate and in real time through the user interaction with the user devices at the time of providing the multimedia services.

Thereafter, at step 620, the sensed information is acquired through the sensing of the scene representation and the sensory effects and the acquired sensed information is encoded with the binary representation to generate the sensing information data. In this case, the sensed information is defined as the XML document schema as the data format for description as described above and the sensed information of the XLM document schema is encoded with the binary representation.

In this case, the sensed information is already described in more detail and therefore, the detailed description thereof will be omitted herein. In particular, in the sensed information, the information sensed at the multi interaction point sensor, the gaze tracking sensor, and the wind sensor, that is, the multi interaction point sensor type, the gaze tracking sensor type, and the wind sensor type are defined as the XML representation syntax, the descriptor components semantics, and the binary representation syntax.

Next, at step 630, the sensing information data encoded with the binary representation are transmitted to the server, wherein the server generates the event data through the sensing information data and then, generates the device command data for driving and controlling the user devices and transmits the generated device command data to the user devices as described above. In this case, the device command data are encoded with the binary representation and are transmitted to the user devices. In this case, the user devices are driven and controlled by the device command data to provide the scene representation and the sensory effects for the multimedia contents of the multimedia services to the users through the user interaction, thereby providing the high quality of various multimedia services requested by the users at a high rate and in a real time.

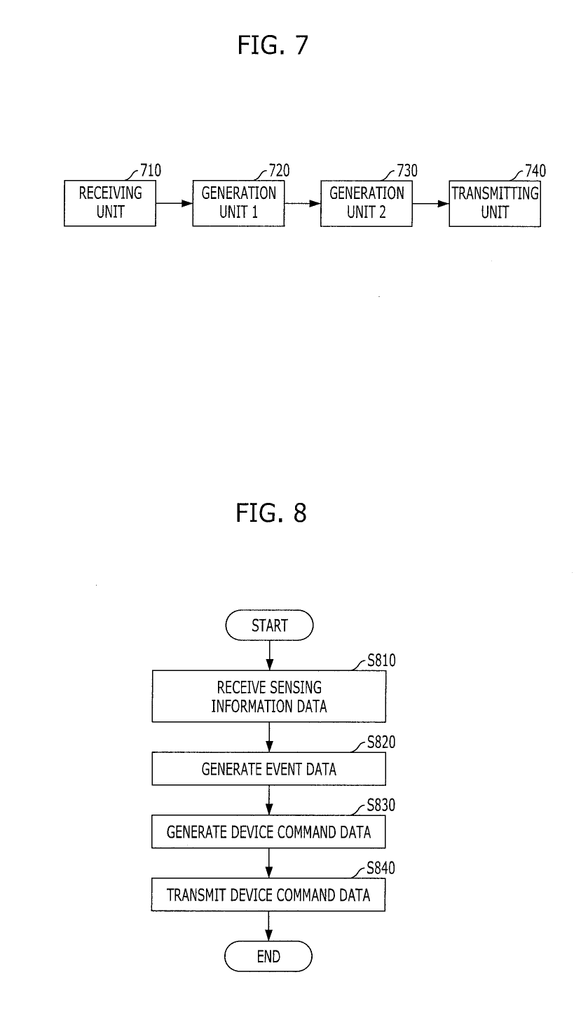

Hereinafter, the server in the system for providing multimedia services in accordance with the exemplary embodiment of the present invention will be described in more detail with reference to FIG. 7.

FIG. 7 is a diagram schematically illustrating a structure of the server in the system for providing multimedia services in accordance with the exemplary embodiment of the present invention.

Referring to FIG. 7, as described above, the server includes a receiving unit 710 that receives the sensing information data including the scene representation, the sensory effects, or the like, for the multimedia contents from the multi-points so as to provide the high quality of various multimedia services to the users, a generation unit 720 that generates the event data by confirming the sensed information from the sensing information data, a generation unit 2 730 that generates the device command data so as to drive and control the user devices according to the event data, and a transmitting unit 740 that transmits the device command data to the user devices, that is, the actuators.

The receiving unit 710 receives the sensing information data for the scene representation and the sensory effects for the multimedia contents transmitted from the multi-points so as to provide the scene representation and the sensory effects for the multimedia contents of the multimedia services through the user interaction at the time of providing the multimedia services. In this case, the sensing information data include the sensed information encoded with the binary representation and the sensed information includes the information regarding the scene representation and the sensory effects for the multimedia contents.

In this case, the sensed information is defined as the types and attributes of the sensor, that is, the types and attributes of the multi-points as described in Tables 1 and 2 and the sensed information is already described in detail and therefore, the detailed description thereof will be omitted.

In addition, as described above, the sensed information defined as the types and attributes as shown in Tables 1 and 2, that is, the light sensor type, the ambient noise sensor type, the temperature sensor type, the humidity sensor type, the distance sensor type, the length sensor type, the atmospheric pressure sensory type, the position sensor type, the velocity sensor type, the acceleration sensor type, the orientation sensor type, the angular velocity sensor type, the angular acceleration velocity sensor type, the force sensor type, the torque sensor type, the pressure sensor type, the motion sensor type, the intelligent camera sensor type, the multi interaction point sensor type (or multi point sensor type), the gaze tracking sensor type, and the wind sensor type are described as the XML document and are also encoded by the binary representation and transmitted to the server.

The generation unit 1 720 confirms the sensed information of the received sensing information data to generate the event data according to the sensed information. In this case, the event data includes the sensed information so as to the scene representation and the sensory effects for the multimedia contents to the users at the time of providing the multimedia services by transmitting the sensed information to the user devices. That is, the event data defines the information value corresponding to the sensed information so as to provide the scene representation and the sensory effects for the multimedia contents by transmitting the sensed information to the user devices.

The generation unit 2 730 receives the event data generates the device command data so as to provide the scene representation and the sensory effects for the multimedia contents by driving and controlling the user devices according to the sensed information included in the event data. Further, the generation unit 2 730 encodes the device command data with the binary representation, similar to the method of encoding the sensed information at the multi-points with the binary representation as described above.

In this case, the device command data become the driving and control information so as to allow the user devices to provide the scene representation and the sensory effects for the multimedia contents at the time of providing the multimedia services. In addition, the device command data are defined as an elements having attribute values of ‘xlink:href’ and ‘deviceCommand’, for example, ‘LASeR sendDeviceCommand Element’ or is defined including elements having an attribute value of ‘xlink:href’ and a sub element, for example, ‘foreign namespace’ similar to ‘SVG foreignObject element’ and is also defined as a command type, for example, ‘SendDeviceCommand’ of a ‘LASeR command’ type.

Further, the transmitting unit 740 transmits the device command data encoded with the binary representation to the user devices, that is, the actuators 130, 132, and 134. Hereinafter, the event data and the device command data according to the sensed information, that is, the sensed information defined as the types and attributes of the sensor as shown in Tables 1 and 2 will be described in more detail.

First, the event data are defined corresponding to the sensed information so as to provide the scene representation and the sensory effects for the multimedia contents by transmitting the sensed information to the user devices in the Part 5 of MPEG-V as described above. For example, the IDL of the event data is defined as shown in Table 22 so as to allow the event data to transmit the information value of the sensed information, that is, transmit the sensed information to the user devices according to the sensed information as shown in Tables 1 and 2.

TABLE 22

```
interface externalSensorEvent : LASeREvent {
      typedef float fVectorType[3];
      typedef sequence<fVectorType> fVectorListType;
    readonly attribute string unitType;
    readonly attribute float time;
    readonly attribute float fValue;
    readonly attribute string sValue;
    readonly attribute fVectorType fVectorValue;
    readonly attribute fVectorListType fVectorList1;
    readonly attribute fVectorListType fVectorList2;
};
```

In Table 3, ‘fVectorType’ defines a 3D vector type configured as three float type variables, ‘VectorListType’ defines a list type having at least one float type vector, and ‘unitType’ defines a string type unit type (for example, Lux, Celsius, Fahrenheit, mps, mlph). In addition, in Table 3, ‘time’ means float type sensed time information, ‘fValue’ means a float type value, and ‘sValue’ means a string type value. Further, in FIG. 3, ‘fVectorValue’ means a value having the float type vector type, ‘fVectorList1’ means values a float type vector list type, and ‘fVectorList2’ means values having a float type vector list type.

In addition, the event data are defined as the types and attributes of the event corresponding to the sensed information defined as the types and attributes of the sensor as in Tables 1 and 2. The event data includes, for example, a light event type, an ambient noise event type, a temperature event type, a humidity event type, a distance event type, a length event type, an atmospheric pressure event type, a position event type, a velocity event type, an acceleration event type, an orientation event type, an angular velocity event type, an angular acceleration event type, a force event type, a torque event type, a pressure event type, a motion event type, an intelligent camera event type, or the like, according to the type of the event. In addition, the event data includes a multi-interaction point sensor event type (or multi point sensor event type), a gaze tracking sensor event type, and a wind event type.

In addition, the event data, that is, the event types have time and unit attributes and may be represented by context information including syntax and semantics as shown in Tables 23 and 24. In Tables 23 and 24, the syntax of each event types is described in detail in Table 22 and the detailed description thereof will be omitted herein.

TABLE 23

| | Context Info | |
|---|---|---|
| Event Type | Syntax | Sematics |
| Light | Value | Describes the value of the light |
| | | sensor with respect to Lux. |
| | sValue | Describes the color which the |
| | | lighting device can provide as a |
| | | reference to a classification scheme |
| | | term or as RGB value. |
| AmbientNoise | fValue | Describes the value of the ambient |
| | | noise sensor with respect to decibel |
| | | (dB) |
| Temperature | fValue | Describes the value of the |
| | | temperature sensor with respect to |
| | | the celsius scale. |
| Humidity | fValue | Describes the value of the humidity |
| | | sensor with respect to percent (%). |
| Length | fValue | Describes the value of the length |
| | | sensor with respect to meter (m). |
| Atmospheric | fValue | Describes the value of the |
| pressure | | atmospheric pressure sensor with |
| | | respect to hectopascal (hPa). |
| Position | fVectorValue | Describes the 3D value of the |
| | | position sensor with respect to |
| | | meter (m). |
| Velocity | fVectorValue | Describes the 3D vector value of |
| | | the velocity sensor with respect |
| | | to meter (m/s). |
| Acceleration | fVectorValue | Describes the 3D vector value of |
| | | the acceleration sensor with |
| | | respect to m/s2. |
| Orientation | fVectorValue | Describes the 3D value of the |
| | | orientation sensor with respect to |
| | | meter (radian). |
| AngularVelocity | fVectorValue | Describes the 3D vector value of |
| | | the AngularVelocity sensor with |
| | | respect to meter (radian/s). |
| AngularAcceleration | fVectorValue | Describes the 3D vector value of |
| | | the AngularAcceleration sensor |
| | | with respect to meter (radian/s2). |
| Force | fVectorValue | Describes the 3D value of the force |
| | | sensor with respect to N(Newton). |
| Torque | fVectorValue | Describes the 3D value of the |
| | | torque sensor with respect to |
| | | N-mm (Newton millimeter). |
| Pressure | fValue | Describes the value of the pressure |
| | | with respect to N/mm2 |
| | | (Newton/millimeter square). |
| Motion | fVectorList1 | Describes the 6 vector values: |
| | | position, velocity, acceleration, |
| | | orientation, AngularVelocity, |
| | | AngularAcceleration. |
| Intelligent | fVectorList1 | Describes the 3D position of each |
| Camera | | of the face feature points detected |
| | | by the camera. |
| | fVectorList2 | Describes the 3D position of each |
| | | of the body feature points detected |
| | | by the camera. |
| MultiPointing | fVectorList1 | Describes the 3D pointing |
| Sensor | | information of multi-pointing |
| | | devices. |
| | fValue | Describes the status of a button |
| | | which is included in a multi- |
| | | pointing device. |
| Gaze | fVectorList1 | Describes the 3D position value of |
| Tracking | | an eye. |
| Sensor | fVectorList2 | Describes the 3D direction of a |
| | | gaze. |
| | fValue | Describes the number of eye's |
| | | blinking. |
| | sValue | Indicates which eye generates this |
| | | gaze sensed information. |
| Wind | fVectorList1 | Describes the 3D position value of |
| | | a wind flow. |
| | fVectorList2 | Describes the 3D vector value of |
| | | the wind velocity with respect to |
| | | meter (m/s). |

TABLE 24

| | Context Info | |
|---|---|---|
| Event Type | Syntax | Sematics |
| Light | Value | Describes the value of the light |
| | | sensor with respect to Lux. |
| | sValue | Describes the color which the |
| | | lighting device can provide as a |
| | | reference to a classification scheme |
| | | term or as RGB value. |
| AmbientNoise | fValue | Describes the value of the ambient |
| | | noise sensor with respect to decibel |
| | | (dB) |
| Temperature | fValue | Describes the value of the |
| | | temperature sensor with respect to |
| | | the celsius scale. |
| Humidity | fValue | Describes the value of the humidity |
| | | sensor with respect to percent (%). |
| Length | fValue | Describes the value of the length |
| | | sensor with respect to meter (m). |
| Atmospheric | fValue | Describes the value of the |
| pressure | | atmospheric pressure sensor with |
| | | respect to hectopascal (hPa). |
| Position | fVectorValue | Describes the 3D value of the |
| | | position sensor with respect to |
| | | meter (m). |
| Velocity | fVectorValue | Describes the 3D vector value of |
| | | the velocity sensor with respect |
| | | to meter (m/s). |
| Acceleration | fVectorValue | Describes the 3D vector value of |
| | | the acceleration sensor with respect |
| | | to m/s2. |
| Orientation | fVectorValue | Describes the 3D value of the |
| | | orientation sensor with respect to |
| | | meter (radian). |
| AngularVelocity | fVectorValue | Describes the 3D vector value of |
| | | the AngularVelocity sensor with |
| | | respect to meter (radian/s). |
| AngularAcceleration | fVectorValue | Describes the 3D vector value of |
| | | the AngularAcceleration sensor |
| | | with respect to meter (radian/s2). |
| Force | fVectorValue | Describes the 3D value of the force |
| | | sensor with respect to N(Newton). |
| Torque | fVectorValue | Describes the 3D value of the |
| | | torque sensor with respect to |
| | | N-mm (Newton millimeter). |
| Pressure | fValue | Describes the value of the pressure |
| | | with respect to N/mm2 |
| | | (Newton/millimeter square). |
| Motion | fVectorList1 | Describes the 6 vector values: |
| | | position, velocity, acceleration, |
| | | orientation, AngularVelocity, |
| | | AngularAcceleration. |
| Intelligent | fVectorList1 | Describes the 3D position of each |
| Camera | | of the face feature points detected |
| | | by the camera. |
| | fVectorList2 | Describes the 3D position of each |
| | | of the body feature points detected |
| | | by the camera. |
| MultiInteractiIon- | fValue | Describes the status of an |
| Point | | interaction point. |
| Sensor | | |
| Gaze | fVectorList1 | Describes the 3D position value of |
| Tracking | | an eye. |
| Sensor | fVectorList2 | Describes the 3D direction of a |
| | | gaze. |
| | fValue | Describes the number of eye's |
| | | blinking. |
| Wind | fVectorList1 | Describes the 3D vector value of |
| | | the wind velocity with respect to |
| | | meter (m/s). |

As shown in Tables 23 and 24, the event types of the event data are each defined corresponding to the sensor type of the sensed information as shown in Tables 1 and 2. In particular, the multi interaction point sensor event type (or multi point sensor type), the gaze tracking sensor event type, and the wind event type are each defined corresponding to the multi interaction point sensor type (or multi point sensor type), the gaze tracking sensor type, and the wind sensor type as shown in Tables 1 and 2.

In addition, as shown in Tables 23 and 24, the event data, that is, the event types are represented by the XML document. For example, the temperature event type is represented by the XML document as shown in Table 6 and Table 25 show the XML representation syntax of the temperature event type.

```
TABLE 25
<?xml version=“1.0” encoding=“ISO-8859-1” ?>
<saf:SAFSession xmlns:saf=“urn:mpeg:mpeg4:SAF:2005”
      xmlns:xlink=“http://www.w3.org/1999/xlink”
      xmlns:ev=http://www.w3.org/2001/xml-events
xmlns:lsr=“urn:mpeg:mpeg4:LASeR:2005”
      xmlns=“http://www.w3.org/2000/svg”>
  <saf:sceneHeader>
    <lsr:LASeRHeader />
  </saf:sceneHeader>
  <saf:sceneUnit>
  <lsr:NewScene>
  <svg xmlns=http://www.w3.org/2000/svg >
  <g onTemperature=“Temperature_change(evt)” >
    <text id=“temp_text” x=10” y=“50”> </text>
    <rect id=“temp_rect” x=“50” y=“50” width=“50”
height=“50” fill=“green”/>
  </g>
  <script id=“temp” type=“text/ecmascript”>
    <![CDATA[
      function Temperature_change(evt) {
        var evtText, evtRect, textContent;
        evtText = document.getElementById(“temp_text”);
        evtRect = document.getElementById(“temp_rect”);
        textContent = evt.fValue;
        evtText.firstChild.nodeValue = textContent;
          if(evt.fValue > 30)
          evtRect.setAttributeNS(null,”fill”,”red”);
          else if(evt.fValue < 10)
            evtRect.setAttributeNS(null,”fill”,”blue”);
        else
            evtRect.setAttributeNS(null,”fill”,”green”);
        }
      ]]>
    </script>
    </svg>
  </lsr:NewScene>
  </saf:sceneUnit>
  <saf:endOfSAFSession />
</saf:SAFSession>
```

In this case, the temperature event type represented by the XML representation syntax as shown in Table 25 receives the temperature information from the temperature sensor at the multi-points to represent temperature in figures in the LASeR scene so as to be provided to the users. In addition, Table 25 is a table that shows an example of the temperature event type as the XML representation syntax so as to represent temperature in blue when temperature is 10° or less, in red when temperature is 30° or more, and in green when temperature is in between 10 to 30° while representing temperature.

As described above, the server defines the event data corresponding to the sensed information at the multi-points and drives and generates the device command data and transmits the generated device command data to the user devices so as to the scene representation and the sensory effects for the multimedia contents corresponding to the sensed information at the multi-points to the users by driving and controlling the user devices corresponding to the sensed information.

In this case, describing the device command data in more detail, the device command data includes the information driving and controlling the user devices so as to provide the high quality of various multimedia services to the users through the user interaction with the user devices at the time of providing the multimedia services as described above. In this case, the device command data are defined corresponding to the sensed information at the multi-points sensing the scene representation and the sensory effects for the multimedia contents of the multimedia services.

In other words, the event data are defined as shown in Tables 5 and 6 corresponding to the sensed information and the device command data are defined corresponding to the event data, that is, the device command data are defined corresponding to the sensed information. In this case, the device command data are defined as the schema and the descriptor for driving and controlling the user devices, for example, the actuators. That is, the server defines each schema for the device command data. In particular, so as to provide the high quality of various multimedia services, the device command data are described as the XML document. In this case, the device command data are encoded and transmitted with the binary representation so as to provide the high quality of various multimedia services at a high rate and in real time.

In this case, the types and attributes of the device command data are defined according to the driving and control of the user devices corresponding to the sensed information and the event data. For example, the device command data include a light type, a flash type, a heating type, a cooling type, a wind type, a vibration type, a sprayer type, a scent type, a fog type, a color correction type, an initialize color correction parameter type, a rigid body motion type, a tactile type, a kinesthetic type, or the like.

The types of the device command data may be represented by the XML document, that is the XML representation syntax. The types of the device command data represented by the XML representation syntax are defined by the descriptor components semantics and are also encoded with the binary representation and transmitted to the user devices and thus, may be represented by the binary representation syntax. In this case, Table 26 is a table that shows an example of the device command data of which the types and attributes are defined.

TABLE 26

| Device command type | | Attributes |
|---|---|---|
| DeviceCmdBase Attributes | | Id, deviceIdRef, Activate, |
| | | type |
| Device | Light Type | Intensity, color |
| Commands | Flash Type | Flash Type |
| | Heating Type | Intensity |
| | Cooling Type | Intensity |
| | Wind Type | Intensity |
| | Vibration Type | Intensity |
| | Sprayer Type | sparyingType, Intensity |
| | Scent Type | Scent, Intensity |
| | Fog Type | Intensity |
| | Color correction | SpatialLocator(CoordRef(ref, spatial |
| | Type | Ref), Box(unlocateRegion, |
| | | dim), Polygon(unlocatedRegion, |
| | | Coords)) |
| | | activate |
| | Initial color | ToneReproductionCurves |
| | correction | (DAC_Value, RGB_Value) |
| | parameter Type | ConversionLUT (RGB2XYZ_LUT, |
| | | RGBScalar_Max, Offset_Value, |
| | | Gain_Offset_Gamm, InverseLUT) |
| | | ColorTemperature (xy_value(x, |
| | | y), Y_Value, Correlated_CT) |
| | | InputDeviceColorGamut |
| | | (IDCG_Value, IDCG_Value) |
| | | IlluminanceOfSurround |
| | Rigid body motion | Rigid body motion Type |
| | Type | MoveToward (direction, |
| | | direction, directionZ, speedX, |
| | | speedY, speedZ, accelerationX, |
| | | accelerationY, accelerationZ) |
| | | Incline (PitchAngle, YawAngle, |
| | | RollAngle, PitchSpeed, |
| | | YawSpeed, RollSpeed, |
| | | PitchAcceleration, |
| | | YawAcceleration, |
| | | RollAcceleration) |
| | Tactile Type | array_intensity |
| | Kinesthetic Type | Position(x, y, z), |
| | | Orientation(x, y, z) |
| | | Force(x, y, z), Torque(x, y, z) |

In addition, the device command data become the driving and control information so as to allow the user devices to provide the scene representation and the sensory effects for the multimedia contents at the time of providing the multimedia services as described above. In particular, the device command data are defined by elements so as to transmit the driving and control information, that is, the device commands by the predetermined user devices providing the scene representation and the sensory effects for the multimedia contents. For example, the device command data are defined by an element having attribute values of ‘xlink:href’ and ‘deviceCommand’, that is, ‘LASeR sendDeviceCommand Element’.

In the case, the ‘xlink:href’ is an attribute value that means the user device receiving the device commands, that is, a target actuator as a target user device in the Part 5 of MPEG-V and the ‘deviceCommand’ is an attribute value that means the function information of the predetermined operations to be performed by the target user device, that is, the device command information so as to provide the scene representation and the sensory effects for the multimedia contents to the users according to the predetermined driving and control information transmitted to the target user device, that is, the sensed information at the multi-points.

As an example of the device command data defined as the elements having the attribute values of the ‘xlink:href’ and ‘deviceCommand’, the device command data of the light type in Table 7 is represented by the XML document as shown in Table 27. Table 27 is a table representing the XML representation syntax of the device command data of the light type.

```
TABLE 27
<?xml version=“1.0” encoding=“ISO-8859-1” ?>
<saf:SAFSession xmlns:saf=“urn:mpeg:mpeg4:SAF:2005”
        xmlns:xlink=“http://www.w3.org/1999/xlink”
        xmlns:ev=http://www.w3.org/2001/xml-events
xmlns:lsr=“urn:mpeg:mpeg4:LASeR:2005”
        xmlns=“http://www.w3.org/2000/svg”>
  <saf:sceneHeader>
    <lsr:LASeRHeader />
  </saf:sceneHeader>
  <saf:sceneUnit>
  <lsr:NewScene>
  <svg xmlns=http://www.w3.org/2000/svg >
    <g>
      <rect id=“rect_Red” x=“50” y=“50” width=“50”
height=“50” fill=“red”/>
      <rect id=“rect_Blue” x=“50” y=“50” width=“50”
height=“50” fill=“blue”/>
    <lsr:sendDeviceCommand begin=“rect_Red.click”
xlink:href=“fdc1”
      deviceCommand=“
        &lt;iidl:InteractionInfo&gt;
          &lt;iidl:DeviceCommandList&gt;
            &lt;iidl:DeviceCommand
xsi:type=&quot;dcv:LightType&quot;
            id=&quot;light1&quot;
deviceIdRef=&quot;fdc1&quot;
        color=&quot;urn:mpeg:mpeg-v:01-SI-ColorCS-
NS:red&quot; intensity=&quot;5&quot;/&gt;
        &lt;/iidl:DeviceCommandList&gt;
        &lt;/iidl:InteractionInfo&gt;”
    </lsr:sendCommandDevice>
    <lsr:sendDeviceCommand begin=“rect_Blue.click”
xlink:href=“fdc1”
      deviceCommand=“
        &lt;iidl:InteractionInfo&gt;
        &lt;iidl:DeviceCommandList&gt;
        &lt;iidl:DeviceCommand
xsi:type=&quot;dcv:LightType&quot;
        id=&quot;light1&quot; deviceIdRef=&quot;fdc1&quot;
      color=&quot;urn:mpeg:mpeg-v:01-SI-ColorCS-
NS:blue&quot; intensity=&quot;5&quot;/&gt;
        &lt;/iidl:DeviceCommandList&gt;
        &lt;/iidl:InteractionInfo&gt;”
    </lsr:SendDeviceCommand>
    </g>
  </svg>
  </lsr:NewScene>
  </saf:sceneUnit>
  <saf:endOfSAFSession />
</saf:SAFSession>
```

In this case, as shown in Table 27, the device command data of the light type represented by the XML representation syntax are an example of the device command changing the light user device, that is, the light actuator to a red color when a red box is selected in the LASeR scene and changing the light actuator to a blue color when the a blue box is selected therein.

As described above, the device command data are defined by ‘LASeR sendDeviceCommand Element’ including an element having the attribute values of the ‘xlink:href’ and the ‘deviceCommand’ and elements having an attribute value of ‘xlink:href’ and ‘foreign namespace’ similar to ‘SVG foreignObject element’ as the sub element so as to transmit the driving and control information, that is, the device commands by the predetermined user devices providing the scene representation and the sensory effects for the multimedia contents. In this case, the ‘xlink:href’ is an attribute value that means the user device receiving the device command, that is, the target actuator as the target user device in the Part 5 of MPEG-V.

As an example of the device command data defined as the element having the attribute value of the ‘xlink:href’ and including the ‘foreign namespace’ as the sub element, the device command data of the light type in Table 7 is represented by the XML document as shown in Table 28. Table 28 is a table representing the XML representation syntax of the device command data of the light type.

```
TABLE 28
<?xml version=“1.0” encoding=“ISO-8859-1” ?>
<saf:SAFSession xmlns:saf=“urn:mpeg:mpeg4:SAF:2005”
        xmlns:xlink=“http://www.w3.org/1999/xlink”
        xmlns:ev=http://www.w3.org/2001/xml-events
xmlns:lsr=“urn:mpeg:mpeg4:LASeR:2005”
        xmlns=“http://www.w3.org/2000/svg”
xmlns:dcv=“urn:mpeg:mpeg-v:2010:01-DCV-NS”
        xmlns:iidl=“urn:mpeg:mpeg-v:2010:01-IIDL-NS”>
  <saf:sceneHeader>
    <lsr:LASeRHeader />
  </saf:sceneHeader>
  <saf:sceneUnit>
  <lsr:NewScene>
  <svg xmlns=http://www.w3.org/2000/svg >
    <g>
    <rect id=“rect_Red” x=“50” y=“50” width=“50” height=“50”
fill=“red”/>
    <rect id=“rect_Blue” x=“50” y=“50” width=“50” height=“50”
fill=“blue”/>
  <lsr:sendDeviceCommand begin=“rect_Red.click”
xlink:href=“fdc1>
      <iidl:InteractionInfo>
          <iidl:DeviceCommandList>
          <iidl:DeviceCommand xsi:type=“dcv:LightType”
id=“light1” deviceIdRef=“fdc1”
            color=“urn:mpeg:mpeg-v:01-SI-ColorCS-NS:red”
intensity=“5”/>
        </iidl:DeviceCommandList>
      </iidl:InteractionInfo>
  </lsr:sendDeviceCommand>
  <lsr:sendDeviceCommand begin=“rect_Blue.click”
xlink:href=“fdc1”>
      <iidl:InteractionInfo>
        <iidl:DeviceCommandList>
          <iidl:DeviceCommand xsi:type=“dcv:LightType”
id=“light1” deviceIdRef=“fdc1”
            color=“urn:mpeg:mpeg-v:01-SI-ColorCS-NS:blue”
intensity=“5”/>
          </iidl:DeviceCommandList>
        </iidl:InteractionInfo>
      </lsr:SendDeviceCommand>
    </g>
    </svg>
  </lsr:NewScene>
  </saf:sceneUnit>
  <saf:endOfSAFSession />
</saf:SAFSession>
```

In this case, as shown in Table 28, the device command data of the light type represented by the XML representation syntax are an example of the device command changing the light user device, that is, the light actuator to a red color when a red box is selected in the LASeR scene and changing the light actuator to a blue color when the a blue box is selected therein.

In addition, the device command data become the driving and control information so as to allow the user devices to provide the scene representation and the sensory effects for the multimedia contents at the time of providing the multimedia services as described above. In particular, the device command data are defined by the element types and the command types described in Tables 27 and 28 so as to transmit the driving and control information, that is, the device commands by the predetermined user devices providing the scene representation and the sensory effects for the multimedia contents. For example, the device command data are defined by the ‘SendDeviceCommand’ of the ‘LASeR command’ as the command type. In this case, the device command data defined by the ‘SendDeviceCommand’ of the ‘LASeR command’ type has the attribute values of the ‘deviceIdRef’ and ‘deviceCommand’.

Further, in the device command data defined by the ‘SendDeviceCommand’ of the ‘LASeR command’ type, the ‘deviceIdRef’ is an attribute value that means the user device receiving the device commands, that is, the target actuator as the target user device in the Part 5 of MPEG-V and the ‘deviceCommand’ is the attribute value that means the function information of the predetermined operations to be performed by the target user device, that is, the device command information so as to provide the scene representation and the sensory effects to the users according to the predetermined driving and control information transmitted to the target user device, that is, the sensed information at the multi-points.

As an example of the device command data defined as the ‘SendDeviceCommand’ the ‘LASeR command’ type having the attribute values of the ‘deviceIdRef’ and ‘cleviceCommand’, the device command data of the light type in Table 26 is represented by the XML document as shown in Table 29. Table 29 is a table representing the XML representation syntax of the device command data of the light type.

```
TABLE 29
<?xml version=“1.0” encoding=“ISO-8859-1” ?>
<saf:SAFSession xmlns:saf=“urn:mpeg:mpeg4:SAF:2005”
          xmlns:xlink=“http://www.w3.org/1999/xlink”
        xmlns:ev=http://www.w3.org/2001/xml-events
xmlns:lsr=“urn:mpeg:mpeg4:LASeR:2005”
        xmlns=“http://www.w3.org/2000/svg”>
  <saf:sceneHeader>
    <lsr:LASeRHeader />
  </saf:sceneHeader>
  <saf:sceneUnit>
  <lsr:NewScene>
  <svg xmlns=http://www.w3.org/2000/svg >
  <g>
    <rect id=“rect_Red” x=“50” y=“50” width=“50” height=“50”
fill=“red”/>
    <rect id=“rect_Blue” x=“50” y=“50” width=“50” height=“50”
fill=“blue”/>
  </g>
  <lsr:conditional begin=“rect_Red.click”>
      <lsr:SendDeviceCommand deviceIdRef=“fdc1”
      deviceCommand=“
        &lt;iidl:InteractionInfo&gt;
        &lt;iidl:DeviceCommandList&gt;
          &lt;iidl:DeviceCommand
xsi:type=&quot;dcv:LightType&quot;
          id=&quot;light1&quot; deviceIdRef=&quot;fdc1&quot;
      color=&quot;urn:mpeg:mpeg-v:01-SI-ColorCS-NS:red&quot;
intensity=&quot;5&quot;/&gt;
        &lt;/iidl:DeviceCommandList&gt;
        &lt;/iidl:InteractionInfo&gt;”
      </lsr:SendDeviceCommand>
  </lsr:conditional>
  <lsr:conditional begin=“rect_Blue.click”>
      <lsr:SendDeviceCommand deviceIdRef=“fdc1”
        deviceCommand=“
          &lt;iidl:InteractionInfo&gt;
          &lt;iidl:DeviceCommandList&gt;
            &lt;iidl:DeviceCommand
xsi:type=&quot;dcv:LightType&quot;
            id=&quot;light1&quot; deviceIdRef=&quot;fdc1&quot;
        color=&quot;urn:mpeg:mpeg-v:01-SI-ColorCS-NS:blue&quot;
intensity=&quot;5&quot;/&gt;
        &lt;/iidl:DeviceCommandList&gt;
        &lt;/iidl:InteractionInfo&gt;”
      </lsr:SendDeviceCommand>
    </lsr:conditional>
  </svg>
  </lsr:NewScene>
    </saf:sceneUnit>
  <saf:endOfSAFSession />
</saf:SAFSession>
```

In this case, as shown in Table 29, the device command data of the light type represented by the XML representation syntax are an example of the device command changing the light user device, that is, the light actuator to a red color when a red box is selected in the LASeR scene and changing the light actuator to a blue color when the a blue box is selected therein.

As described above, the multimedia system in accordance with the exemplary embodiment of the present invention senses the scene representation and the sensory effects for the multimedia contents of the multimedia services in the multi-points so as to provide the high quality of various multimedia services requested by users at a high rate and in real time through the user interaction with the user devices at the time of providing the multimedia services in the MPEG-V and defines the data format for describing the sensed information acquired through the sensing, that is, defines the data format by the XML document schema and encodes and transmits the defined sensed information by the binary representation. The user interaction with the user devices is performed at the time of providing the multimedia services by generating the event data based on the sensed information encoded with the binary representation and the device command data based on the sensed information and the event data and then encoding the data with the binary representation code and the encoded data to the user devices, such that the high quality of various multimedia services requested by the users are provided to the users at a high rate and in real time. Hereinafter, the generation and transmission operations of the event data and the device command data of the server for driving and controlling the user devices so as to providing the multimedia services in the multimedia system in accordance with the exemplary embodiment of the present invention will be described in more detail with reference to FIG. 8.

FIG. 8 is a diagram schematically illustrating an operation process of the server in the multimedia system in accordance with the exemplary embodiment of the present invention.

Referring to FIG. 8, at step 810, the server receives the sensed information of the scene representation and the sensory effects for the multimedia contents of the multimedia services, that is, the sensing information data obtained by encoding the sensed information with the binary representation from the multi-points so as to provide the high quality of various multimedia services requested by the users in a high rate and in real time through the user interaction with the user devices at the time of providing the multimedia services. In this case, the sensed information is as described in Tables 1 and 2.

Thereafter, at step 820, the event data are generated by receiving the sensing information data and confirming the sensed information at the multi-points through the received sensing information data, that is, the scene representation and the sensory effects for the multimedia contents.

Next, at step 830, the device command data driving and controlling the user devices are generated in consideration the event data, that is, the sensed information. In this case, the device command data are encoded with the binary representation. In this case, the event data and the device command data corresponding to the sensed information is already described in detail and therefore, the detailed description thereof will be omitted.

At step 840, the device command data are transmitted to the user devices, that is, the actuators. In this case, the user devices are driven and controlled by the device command data to provide the scene representation and the sensory effects for the multimedia contents sensed at the multi-points to the users through the user interaction, thereby providing the high quality of various multimedia services requested by the users at a high rate and in a real time.

The exemplary embodiments of the present invention can stably provide the high quality of various multimedia services that the users want to receive, in particular, can provide the high quality of various multimedia services to the users at a high rate and in real time by transmitting the multimedia contents and the information acquired at the multi-points at the time of providing the multimedia contents at a high rate.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

What is claimed is:

1. A system for providing multimedia services in a communication system, comprising:
a sensing unit configured to sense scene representation and sensory effects for multimedia contents corresponding to multimedia services according to service requests of the multimedia services that users want to receive;
a generation unit configured to generate sensed information corresponding to sensing of the scene representation and the sensory effects; and
a transmitting unit configured to encode the sensed information with binary representation and transmit the encoded sensed information to a server.

2. The system of claim 1, wherein the sensing unit senses the scene representation and the sensor effects for the multimedia contents at multi-points so as to provide the multimedia services through user interaction with user devices at the time of providing the multimedia services.

3. The system of claim 1, wherein the sensed information is defined as sensor types and attributes of multi-points and includes at least one of a multi interaction point sensor type, a gaze tracking sensor type, and a wind sensor type.

4. The system of claim 3, wherein the at least one sensor type is defined as an eXtensible markup language (XML) document schema and encoded with the binary representation and transmitted to the server.

5. The system of claim 3, wherein the at least one sensor type is defined as an eXtensible markup language (XML) representation syntax, descriptor components semantics, and a binary representation syntax.

6. The system of claim 5, wherein the multi interaction point sensor type includes a descriptor for describing position information of the multi-points as spatial coordinates of x, y, and z and a descriptor for describing whether or not to select the multi-points.

7. The system of claim 5, wherein the gaze tracking sensor type includes a descriptor for describing position and orientation of user's eyes and a descriptor for describing a blink of user's eyes as ‘on/off’, a descriptor for describing an identifier (ID) of the users, and a descriptor for describing a gaze direction of the left eye or the right eye of the users and the gaze direction of the left eye or the right eye of the users.

8. The system of claim 5, wherein the wind sensor type includes a descriptor for describing wind direction and wind velocity.

9. The system of claim 1, wherein the sever receives the sensed information and transmits device command data for the sensed scene representation and sensory effects to the user devices; and
the user devices are driven and controlled by the device command data to provide the scene representation and the sensory effects for the multimedia contents to the users.

10. A system for providing multimedia services in a communication system, comprising:
a receiving unit configured to receive sensed information at multi-points for scene representation and sensory effects for multimedia contents corresponding to the multimedia services from the multi-points according to service requests that users want to receive;
a generation unit configured to generate event data and device command data corresponding to the sensed information; and
a transmitting unit configured to encode the device command data with binary representation and transmit the encoded device command data to the user devices.

11. The system of claim 10, wherein the multi-points sense the scene representation and the sensor effects for the multimedia contents so as to provide the multimedia services through user interaction with user devices at the time of providing the multimedia services.

12. The system of claim 10, wherein the sensed information is defined as sensor types and attributes of multi-points, and
the event data define event types corresponding to the sensor type.

13. The system of claim 10, wherein the device command data are defined as an eXtensible markup language (XML) document schema for the scene representation and the sensory effects for the multimedia contents corresponding to the sensed information and transmitted to the user devices.

14. A system of claim 10, wherein the device command data are defined as an eXtensible markup language (XML) representation syntax, descriptor components semantics, and a binary representation syntax.

15. The system of claim wherein the device command data are defined as elements including attribute values meaning a target user device and an attribute values meaning driving and control information of the target user device among the user devices.

16. The system of claim 14, wherein the device command data are defined as an element including the attribute values meaning the target user device and a sub element among the user devices.

17. The system of claim 14, wherein the device command data are defined as a command type including the attribute values meaning the target user device and the attribute values meaning the driving and control information of the target user device among the user devices.

18. The system of claim 10, wherein the user devices receive the device command data and are driven and controlled by the device command data to provide the scene representation and the sensory effects for the multimedia contents to the users.

19. A method for providing multimedia services in a communication system, comprising:
sensing scene representation and sensory effects for multimedia contents corresponding to multimedia services through multi-points according to service requests of the multimedia services that users want to receive;
generating sensed information for the scene representation and the sensor effects corresponding to sensing at the multi-points; and
encoding the sensed information with binary representation and transmitting the encoded sensed information.

20. A method for providing multimedia services in a communication system, comprising:
receiving sensed information at multi-points for scene representation and sensory effects for multimedia contents corresponding to the multimedia services according to service requests of multimedia services that users want to receive;
generating event data corresponding to the sensed information;
generating device command data based on the sensed information and the event data; and
encoding and transmitting the device command data by binary representation so as to drive and control user devices.
